(19) United States
(12) Patent Application Publication
(10) Pub. No.: US 2026/0303356 A1
(43) Pub. Date: Oct. 1, 2026

(54) MOVING-IMAGE FILE GENERATION DEVICE, IMAGING DEVICE, VERIFICATION DEVICE, AND CONTROL METHOD OF MOVING-IMAGE FILE GENERATION DEVICE

(71) Applicant: CANON KABUSHIKI KAISHA, Tokyo (JP)

(72) Inventor: NOBUYUKI TSUKAMOTO, Tokyo (JP)

(21) Appl. No.: 19/564,819

(22) Filed: Mar. 12, 2026

(30) Foreign Application Priority Data
Mar. 26, 2025 (JP) 2025-051452

(51) Int. Cl. H04L 9/32; H04N 5/91

(52) U.S. Cl. CPC H04L 9/3247; H04N 5/91

(57) ABSTRACT

A moving-image file generation device according to the present disclosure includes a processor and a memory storing a program which, when executed by the processor, causes the moving-image file generation device to allow a user to designate, for moving-image data including a plurality of chunks, an authenticity assurance range representing a range of a moving-image for which authenticity is assured, acquire, for each chunk, verification data used to verify tampering with data of the chunk, and generate a moving-image file in which at least information indicating the authenticity assurance range designated for the moving-image data, the verification data for each chunk, and the moving-image data are stored.

### BACKGROUND

### Field of the Technology

The present disclosure relates to a technology for verifying the authenticity of moving-image content.

### Description of the Related Art

In recent years, information sharing via the Internet has been actively carried out, and anyone is able to disclose and transmit various kinds of information to the general public. Furthermore, various kinds of processing can be easily performed on digital images using image editing software or the like. Under such circumstances, problems have arisen in which information is transmitted from unreliable sources and disclosed information is illegally tampered with.

In order to address these problems, there is a mechanism in which a digital camera generates hash values from image data during imaging and outputs the image data with the hash values added thereto, thereby assuring the authenticity of the image. A verification device generates hash values from the image data and confirms a match between the generated hash values and the hash value added to the image, thereby making it possible to verify the presence or absence of tampering with the image data.

Furthermore, in order to authenticate the source, history, or provenance of an image, it has been proposed to add metadata indicating content of editing performed on the image to the image (see Coalition for Content Provenance and Authenticity (C2PA), <Technical Specifications Version 1.2>).

According to the technology of Coalition for Content Provenance and Authenticity (C 2PA), <Technical Specifications Version 1.2>, a digital camera generates a hash value for each chunk, which refers to a collection of a specified number of frame images, during imaging of a moving image, adds the hash values to a moving-image file as a hash list, and outputs the moving-image file. Furthermore, a verification device similarly generates a hash value for each chunk from the moving-image file and compares the generated hash values with the hash list added to the moving-image file, thereby making it possible to verify tampering with the moving-image file.

However, because a moving-image file generally includes a large number of chunks, it takes a considerable amount of time to generate hash values for all of the chunks and compare the hash values with a hash list to verify tampering with the moving-image file. In particular, for moving images having higher frame rates or longer durations, the problem of increased verification time becomes more pronounced.

### SUMMARY

The present disclosure has been made in view of the above circumstances and provides a technology for shortening the time required to verify tampering with moving-image files.

The present disclosure provides a moving-image file generation device according to the present disclosure including a processor and a memory storing a program which, when executed by the processor, causes the moving-image file generation device to allow a user to designate, for moving-image data including a plurality of chunks, an authenticity assurance range representing a range of a moving-image for which authenticity is assured, acquire, for each chunk, verification data used to verify tampering with data of the chunk, and generate a moving-image file in which at least information indicating the authenticity assurance range designated for the moving-image data, the verification data for each chunk, and the moving-image data are stored.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating an example of the configuration of an authenticity verification system.

FIG. 2 is a block diagram illustrating an example of the configuration of an imaging device.

FIG. 3 is a block diagram illustrating an example of the configuration of a verification device.

FIG. 4 is a flowchart illustrating an example of the operation of the imaging device during recording.

FIG. 5 is a diagram illustrating an example of chunk marking in a moving-image file.

FIG. 6 is a diagram illustrating an example of the configuration of a moving-image file.

FIG. 7 is a flowchart illustrating an example of the verification operation of the verification device.

FIG. 8 is a flowchart illustrating an example of the operation of the imaging device during reproduction.

FIG. 9 is a flowchart illustrating an example of the operation of the imaging device during cutting and editing.

### DESCRIPTION OF THE EMBODIMENTS

Hereinafter, preferred embodiments of the present disclosure will be described in detail by way of example with reference to the drawings. However, the components described in the embodiments are merely examples and do not limit the scope of the present disclosure.

### First Embodiment

### Overall Configuration of System

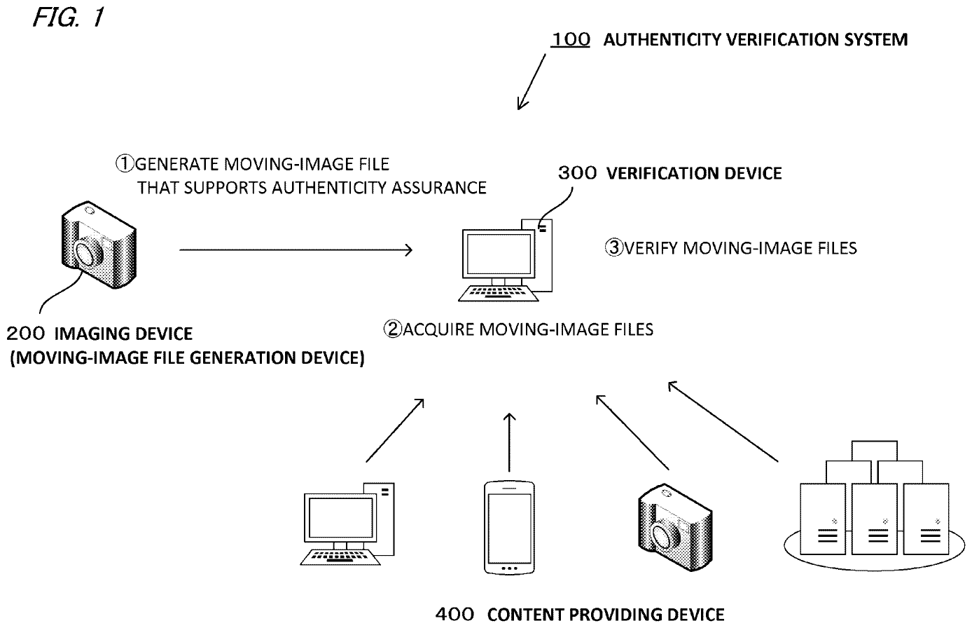

FIG. 1 is a diagram illustrating an example of the configuration of an authenticity verification system 100. The authenticity verification system 100 includes an imaging device 200, a verification device 300, and a content providing device 400. A moving-image file generation device according to the present disclosure is implemented as one function of the imaging device 200 or one function of the content providing device 400.

The imaging device 200 generates, during imaging, a moving-image file that supports authenticity assurance. The generated moving-image file is transferred, via a recording medium such as an SD card or via a network, to the verification device 300 or the content providing device 400.

The verification device 300 is capable to acquiring moving-image files to be verified from external devices, such as the imaging device 200 and the content providing device 400, via recording media or a network. The content providing device 400 includes, for example, a PC, a smartphone, a tablet, an imaging device different from the imaging device 200, a WEB server device (an image sharing site, etc.), and the like. The content providing device 400 has an editing tool, such as moving-image editing application software, installed therein and is capable of freely editing moving-image files. Furthermore, the content providing device 400 may provide moving-image files acquired from other content providing devices to the verification device 300. Furthermore, the imaging device 200 may also have a moving-image editing function. Therefore, moving-image files acquired by the verification device 300 from the external devices may remain unchanged from the moving-image files acquired during imaging, may be properly edited, or may be illegally tampered with. The verification device 300 performs processing to verify the authenticity of moving-image files in order to correctly determine a processing history (particularly, the presence or absence of illegal tampering) of the moving-image files acquired from the external devices.

### Imaging Device

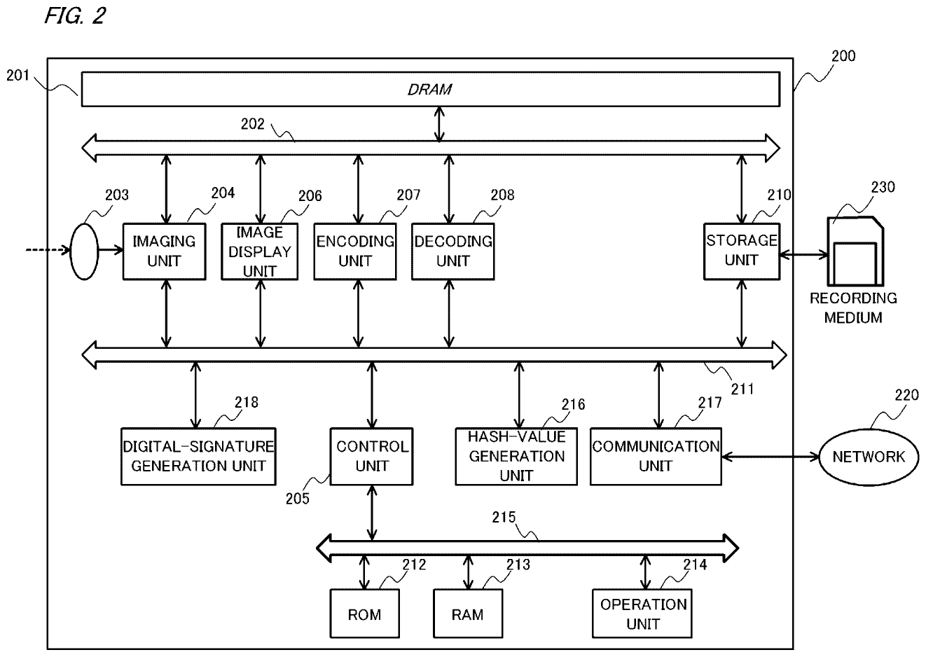

FIG. 2 is a block diagram illustrating an example of the configuration of the imaging device 200 having an authenticity assurance function. The imaging device 200 is, for example, a digital camera, a digital video camera, or electronic equipment such as a mobile phone or a computer device having a camera function. The imaging device 200 is an implementation example of a moving-image file generation device according to the present disclosure.

The imaging device 200 includes a dynamic random access memory (DRAM) 201 that serves as an internal memory and a recording medium 230 that serves as an external memory. The DRAM 201 is a main memory of the imaging device 200 and is capable of temporarily retaining image data, image data read from the recording medium 230, and the like. Access to the DRAM 201 is performed through a data bus 202. The recording medium 230 is attachable to and detachable from the imaging device 200 and is, for example, a memory card such as an SD card.

The imaging device 200 includes, as an imaging system, a lens shutter unit 203 and an imaging unit 204. The lens shutter unit 203 includes a lens and a shutter for imaging a subject. The imaging unit 204 includes an imaging element that converts light from the lens shutter unit 203 into an electrical signal and temporarily retains the converted electrical signal as digital data in the DRAM 201. As the imaging element, a charge coupled device (CCD) sensor, a complementary metal oxide semiconductor (CMOS) sensor, or the like is used.

The imaging device 200 includes, as a control system, a control unit 205, a read only memory (ROM) 212, and a random access memory (RAM) 213. The ROM 212 is a non-volatile memory that stores, in a non-temporary manner, an operation program executed by the control unit 205, and the RAM 213 is a work memory used by the control unit 205. The control unit 205 is, for example, a processor such as a central processing unit (CPU) and controls the operation of each block included in the imaging device 200. The control unit 205 reads an operation program stored in the ROM 212, expands the program in the RAM 213, and executes the program, thereby controlling the operation of each block. The control bus 211 is used by the control unit 205 to provide control instructions to each block. Furthermore, a program bus 215 connects the control unit 205 to the ROM 212, the RAM 213, and an operation unit 214.

The imaging device 200 includes an image display unit 206 and an operation unit 214 as man-machine interfaces. The image display unit 206 reads image data temporarily retained in the DRAM 201 and displays the read image data on the display panel. As the display panel, a liquid crystal display (LCD), an organic electro-luminescence (EL) display, or the like is used. The operation unit 214 is an input interface used by a user to provide instructions to the imaging device 200 and includes a record button, a menu button, a reproduction(playing) button, and the like. Furthermore, the operation unit 214 may include a mark button for specifying (marking) a specific picture (frame image) or a specific chunk during recording, editing, or playing of moving-image data. When the operation unit 214 is operated by the user, the content of the input operation is transmitted to the control unit 205 through the program bus 215.

The imaging device 200 includes, as an image processing system, an encoding unit 207, a decoding unit 208, and a recording unit 210. The encoding unit 207 encodes digital data temporarily retained in the DRAM 201. The encoding unit 207 employs, for example, a moving-image encoding method such as ITU-T H.264 (ISO/IEC 14496-10 MPEG-4 AVC) or ITU-T H.265 (ISO/IEC 23008-2 HEVC). The decoding unit 208 decodes a moving-image file read from the recording medium 230 and writes the decoded moving-image file back into the DRAM 201. The recording unit 210 records encoded data temporarily retained in the DRAM 201 on the recording medium 230 as a moving-image file in a specified file format. Furthermore, the recording unit 210 is also capable of reading a moving-image file in a specified file format recorded on the recording medium 230 and temporarily retaining the read moving-image file in the DRAM 201. Here, a moving-image file in a specified file format refers, for example, to a moving-image that complies with the C2PA standard.

The imaging device 200 includes, as authenticity assurance functions, a hash-value generation unit 216 and a digital-signature generation unit 218. The hash-value generation unit 216 generates (calculates) a hash value by executing a hash function on data retained in the DRAM 201. Note that the control unit 205 may generate a hash value instead of the hash-value generation unit 216. As an algorithm for generating a hash value, for example, SHA-256 (Secure Hash Algorithm 256-bit), SHA-512 (Secure Hash Algorithm 512-bit), or the like is used. The digital-signature generation unit 218 performs, using a secret key prepared in advance, rivest-shamir-adleman (RSA) encryption on data to be signed (Claim) retained in the DRAM 201. Note that the control unit 205 may perform a digital signature instead of the digital-signature generation unit 218.

The imaging device 200 includes a communication unit 217 that communicates with an external device. The communication unit 217 is a wired or wireless communication interface and transmits and receives data to and from the external device via a network 220 such as the Internet.

The imaging device 200 according to the present embodiment includes, as functions for generating a moving-image file that supports authenticity assurance, a range designation function, a verification-data acquisition function, a signature generation function, a moving-image file generation function, and the like. The range designation function is a function that allows the user to designate, for moving-image data, a range (hereinafter referred to as an “authenticity assurance range” or a “verification range”) of a moving image for which authenticity is assured, and is implemented by cooperation between the control unit 205 and the operation unit 214. The verification-data acquisition function is a function that acquires, for each chunk, verification data (a hash value in the above-described example) used to verify tampering with data of the chunk, and is implemented by cooperation between the control unit 205 and the hash-value generation unit 216. The signature generation function is a function that generates a digital signature for information indicating an authenticity assurance range and verification data for each chunk, and is implemented by cooperation between the control unit 205 and the digital-signature generation unit 218. The moving-image file generation function is a function that generates a moving-image file in which information indicating an authenticity assurance range, verification data for each chunk, and moving-image data are stored, and is implemented by the control unit 205. Details of these functions will be described later.

### Verification Device

The verification device 300 may be implemented by a single computer, or may be implemented by a plurality of computers in which functions of the verification device 300 are distributed as appropriate. When the verification device 300 is constituted by a plurality of computers, the computers are connected via a communication line such as a local area network (LAN) or the Internet so as to enable mutual communication.

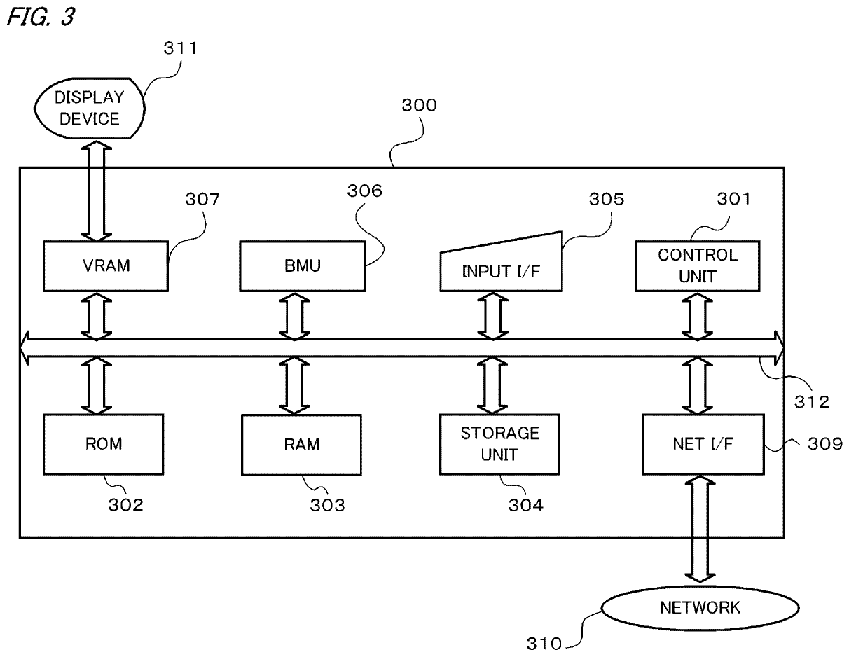

FIG. 3 is a block diagram illustrating an example of the configuration of the verification device 300. In the present embodiment, a personal computer (PC) will be described as an example of the verification device 300. Note that the verification device 300 is not limited to a PC and may be a smartphone or a tablet.

In FIG. 3, a control unit 301 is, for example, a processor such as a central processing unit (CPU). A read only memory (ROM) 302 is a non-volatile memory that stores, in a non-temporary manner, programs or parameters that do not require modification. A random access memory (RAM) 303 is used as a work memory and temporarily stores programs or data. A storage unit 304 is a non-volatile storage unit, such as a hard disk drive (HDD), a solid-state drive (SSD) constituted by a flash memory, or a hybrid drive or a memory card that uses both a hard disk and a flash memory. The storage unit 304 stores programs such as an operating system (OS) and a program for tampering verification, which will be described later. Furthermore, the storage unit 304 stores various data necessary to realize the present embodiment, such as moving-image files to be verified, which will be described later. The operation of the verification device 300 is implemented by developing a program stored in the ROM 302 or the storage unit 304 into the RAM 303 and executing the program by the control unit 301.

An input interface 305 is connected to an input device such as a pointing device or a keyboard and receives an operation input from the user. A bit move unit (BMU) 306 controls data transfer between memories (e.g., between a VRAM 307 and another memory) or between a memory and an I/O device (e.g., a network interface 309).

A video RAM (VRAM) 307 stores image data to be displayed on a display device 311. The image data generated in the VRAM 307 is transmitted to the display device 311 in accordance with predetermined specifications, and the display device 311 displays the image. A network interface 309 connects to a network 310 such as the Internet. A system bus 312 connects the units 301 to 309 so as to enable mutual communication.

The verification device 300 according to the present embodiment includes, as functions for verifying tampering of moving-image files that support authenticity assurance, a moving-image file acquisition function and a verification function. The moving-image file acquisition function is a function that acquires a moving-image file in which information indicating an authenticity assurance range (verification range) and verification data for each chunk are stored. Furthermore, the verification function is a function that performs, on the basis of information indicating an authenticity assurance range stored in a moving-image file, verification of tampering using verification data only for chunks included in the authenticity assurance range within the entire moving-image data. These functions are implemented when the control unit 301 executes a program. Details of the respective functions will be described later.

### Generation of Moving-Image File That Supports Authenticity Assurance

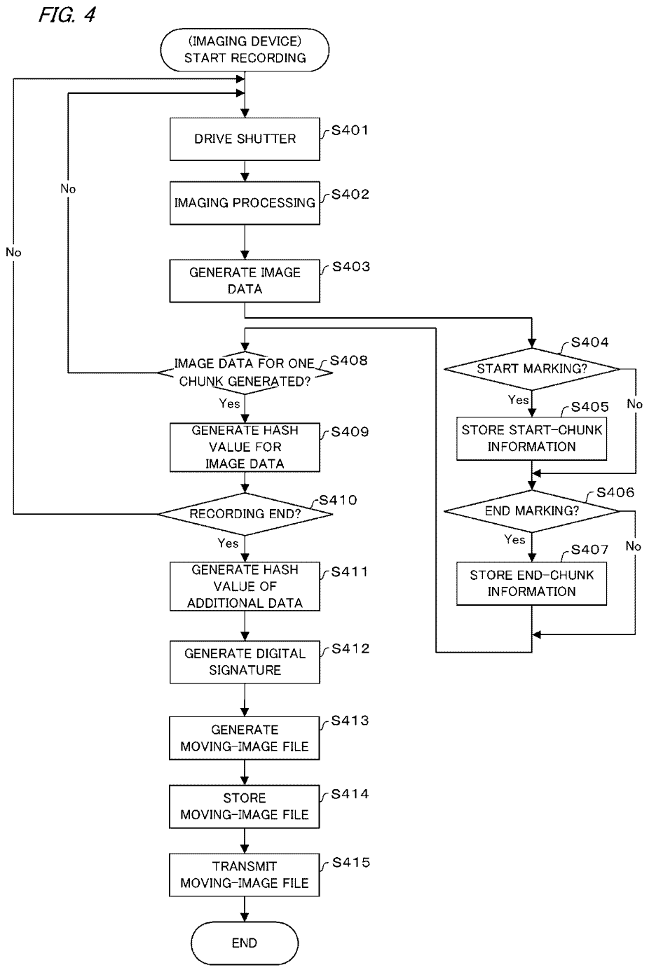

With reference to the flowchart of FIG. 4, processing performed by the imaging device 200 to generate, during imaging, a moving-image file that supports C2PA authenticity assurance will be described. This processing is implemented when the control unit 205 of the imaging device 200 executes a program stored in the ROM 212 or the like. This processing starts when the imaging device 200 receives an imaging start operation (e.g., pressing of an imaging button, which is a part of the operation unit 214) from a user (photographer).

In step S401, the control unit 205 drives the lens shutter unit 203 disposed on a subject side of the imaging unit 204 to control an exposure time. Next, in step S402, in accordance with instructions from the control unit 205, the imaging unit 204 performs imaging processing to convert light from a subject, which is received through the lens shutter unit 203, into an electrical signal (analog image data).

Then, in step S403, the control unit 205 performs image processing, such as development processing and encoding processing performed by the encoding unit 207, on the electrical signal obtained in step S402 by the imaging processing, thereby generating digital image data.

Next, in step S404, the control unit 205 determines whether the imaging device 200 has received a chunk-marking start operation from the user. Chunk-marking refers to an operation for designating the range of a moving image for which authenticity is to be assured (authenticity assurance range). The chunk-marking start operation is an operation for designating a picture or a chunk at a start position. A picture can be designated, for example, by pressing a shot-mark button, which is a part of the operation unit 214. Note that, in addition to the shot-mark button used to designate a picture (frame image), a chunk-mark button used to designate a chunk may be provided, and a chunk at a start position may be designated using the chunk-mark button. When recognizing, during imaging of a moving image, the start of a scene for which authenticity is assured (e.g., a scene of high importance), the user may perform a chunk-marking start operation.

Here, a chunk refers to a group of pictures (GOP), which is a collection of a specified number of images (pictures). In the present embodiment, an image (picture) group corresponding to moving-image data of approximately 0.5 seconds is defined as one chunk. For example, in the case of moving-image data having a frame rate of 30 frames per second (FPS), one chunk represents a collection of image data of 15 pictures (GOP). In the case of moving-image data having a frame rate of 60 FPS, one chunk represents a collection of image data of 30 pictures (GOP).

When the control unit 205 determines in step S404 that the chunk-marking start operation has been received, the processing proceeds to step S405. Otherwise, the processing proceeds to step S406.

In step S405, the control unit 205 stores start-chunk information indicating a chunk-marking start position in the DRAM 201 or the RAM 213.

Next, in step S406, the control unit 205 determines whether the imaging device 200 has received a chunk-marking end operation from the user. The chunk-marking end operation is an operation for designating a picture or a chunk at an end position. A picture can be designated, for example, by pressing a shot-mark button, which is a part of the operation unit 214. Note that when a chunk-mark button is provided, a chunk at the end position may be designated using the chunk-mark button. When recognizing, during imaging of a moving image, the end of a scene for which authenticity is assured (e.g., a scene of high importance), the user may perform the chunk-marking end operation.

When the control unit 205 determines in step S406 that the chunk-marking end operation has been received, the processing proceeds to step S407. Otherwise, the processing proceeds to step S408.

In step S407, the control unit 205 stores end-chunk information indicating a chunk-marking end position in the DRAM 201 or the RAM 213.

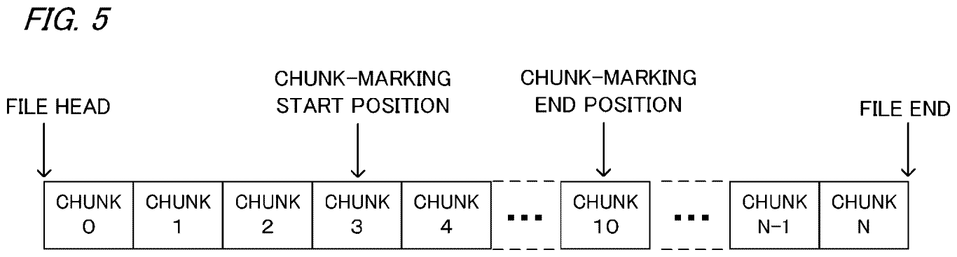

A specific example of the processing of steps S404 to S407 will be described with reference to a chunk-marking example illustrated in FIG. 5.

In FIG. 5, it is assumed that a moving-image file is recorded at a frame rate of 60 FPS, and that each chunk is composed of 30 pictures. That is, chunk 0 indicates the first to 30th pictures after the start of moving-image recording, chunk 1 indicates the 31st to 60th pictures after the start of moving-image recording, and chunk N indicates the (30×N+1)th to (30×(N+1))th pictures after the start of moving-image recording. In the example of FIG. 5, the moving-image recording ends at the (30×(N+1))th picture, and this moving-image file is composed of the N+1 chunks, that is, chunks 0 to N.

For example, it is assumed that the user performed a chunk-marking start operation at the time of the 100th picture after the start of moving-image recording. Then, in step S404 after generation of image data of the 100th picture, the control unit 205 receives the chunk-marking start operation, and the processing proceeds to step S405. In step S405, the control unit 205 determines, as a chunk-marking start position, a chunk to which the picture being recorded at the timing when the chunk-marking start operation was performed belongs. In this example, because the chunk-marking start operation was performed during recording of the 100th picture, the chunk-marking start position corresponds to “chunk 3.” The control unit 205 stores, as start-chunk information, chunk number “3” corresponding to the chunk-marking start position in the DRAM 201 or the RAM 213.

Thereafter, it is assumed that the imaging and recording of the moving image continued, and that, for example, the user performed a chunk-marking end operation at the time of the 315th picture. Then, in step S406 after generation of image data of the 315th picture, the control unit 205 receives the chunk-marking end operation, and the processing proceeds to step S407. In step S407, the control unit 205 determines, as a chunk-marking end position, a chunk to which the picture being recorded at the timing when the chunk-marking end operation was performed belongs. In this example, because the chunk-marking end operation was performed during recording of the 315th picture, the chunk-marking end position corresponds to “chunk 10.” The control unit 205 stores, as end chunk information, chunk number “10” corresponding to the chunk-marking end position in the DRAM 201 or the RAM 213.

In the processing of steps S404 to S407, during imaging and recording of a moving image for moving-image data sequentially acquired from the imaging unit 204, an authenticity assurance range can be designated and recorded by the user's own operation. The processing of steps S404 to S407 may be performed a plurality of times until a recording-end determination (S410) is made. That is, a plurality of authenticity assurance ranges (a plurality of pairs of start-chunk information items and end-chunk information items) may be recorded for a single C2PA moving-image file.

Referring back to FIG. 4, the processing of step S408 and subsequent steps will be described. In step S408, the control unit 205 determines whether image data for one chunk has been generated. When the control unit 205 determines in step S408 that image data for one chunk has been generated, the processing proceeds to step S409. Otherwise, the processing returns to step S401.

In step S409, the control unit 205 executes a hash function on the generated image data for one chunk via the hash-value generation unit 216, thereby generating a hash value.

Next, the processing proceeds to step S410, and the control unit 205 determines whether the imaging device 200 has received an imaging-stop operation from the user. The imaging-stop operation corresponds, for example, to an operation of pressing an imaging button or an imaging-stop button, which is a part of the operation unit 214. When the control unit 205 determines that the imaging-stop operation has been received, the processing proceeds to step S411. Otherwise, the processing returns to step S401 to continue imaging.

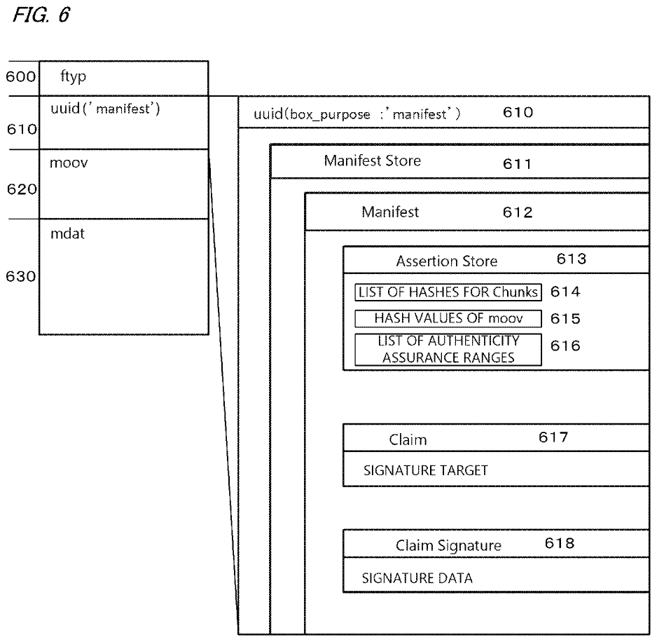

In step S411, the control unit 205 executes a hash function on additional data related to the image data via the hash-value generation unit 216, thereby generating a hash value. The additional data will be described later with reference to a moving-image file format illustrated in FIG. 6.

In step S412, the control unit 205 generates a digital signature via the digital-signature generation unit 218. The digital signature includes information indicating a signature value, a signer, and a signature date and time. The signature value is generated by encrypting the hash values generated in steps S409 and S411 using a secret key prepared in advance. A public key paired with the secret key used here is also stored in the digital signature. In the present embodiment, information indicating the manufacturer of the imaging device 200 is stored as the signer. Note that instead of the manufacturer, the type of the imaging device 200 may be used as the signer. Furthermore, as the signature date and time, the date and time at which generation of the digital signature is completed is stored.

In step S413, the control unit 205 adds the digital signature data generated in step S412 to the image data, thereby generating a moving-image file. The moving-image file is generated in accordance with the specified technical standard illustrated in FIG. 6 (e.g., C2PA (Coalition for Content Provenance and Authenticity)) and has a stipulated structure.

Here, the structure of data generated in the processing of step S409 and steps S411 to S413 will be described with reference to the moving-image file format generated in accordance with the C2PA standard illustrated in FIG. 6.

The moving-image file illustrated in FIG. 6 is a file that complies with the MP4 format standardized in ISO/IEC 14496-14:2003 and has a nested structure including a plurality of boxes.

An ftyp box 600 is added to the head of the moving-image file and indicates that the moving-image file complies with the MP4 format standardized in ISO/IEC 14496-14:2003. A uuid (“manifest”) box 610 follows the ftyp box 600 and stores information for proving the authenticity of the moving-image file. The box_purpose of the uuid box 610 stores “manifest.” A moov box 620 includes management information for the moving-image data. An mdat box 630 includes encoded moving-image data.

In the mdat box 630, all moving-image data recorded in the moving-image file from the start to the end of imaging is recorded. The mdat box 630 includes a plurality of chunks. Each chunk has a plurality of encoded pictures. Each picture is a picture encoded by, for example, H.264, or H.265.

In the moov box 620, various management information items used to reproduce the moving-image data recorded in the mdat box 630 are recorded. The moov box 620 includes an mvhd box that includes header information storing a generation date and time and the like, and a trak box that includes information related to the moving-image data stored in the mdat box 630. The trak box includes an stco box, an stsc box, an stsz box, and the like. The stco box stores information related to an offset value for each chunk in the mdat box 630. The stsc box stores information related to the number of pictures in each chunk. The stsz box stores size information for each picture.

The uuid (“manifest”) box 610 includes one Manifest Store 611, and the Manifest Store 611 includes at least one Manifest 612.

In the Manifest 612, an Assertion Store 613, a Claim 617, and a Claim Signature 618 are retained.

In an Assertion Store 613, Assertions, which are data items including information related to the authenticity of moving images, exemplified as Assertions 614, 615, and 616, are stored. In the Assertion 614, a list of hash values for chunks generated in step S409 is retained. In the Assertion 615, hash values of the moov box 620 generated in step S411 are retained. In the Assertion 616, a list of pairs of start-chunk information items recorded in step S405 and end-chunk information items recorded in step S407 (a list of authenticity assurance ranges) is retained. Because this list is also a list indicating ranges for which authenticity is to be verified on the verification device 300 side, the list may also be referred to as a “list of verification ranges.” For example, when the user determines scenes within the ranges of chunks 3 to 6, chunks 10 to 15, and chunks 23 to 28 as important scenes for which authenticity is assured during imaging and performs a chunk-marking operation, the following list is stored in the Assertion 616. A list of authenticity assurance ranges: {(3, 6), (10, 15), (23, 28)}

In the Claim 617, information such as storage locations of Assertions, hash values of the Assertion Store 613 (generated in step S411), a creator of the Claim 617, and storage locations of digital signatures of the Claim 617 is stored. In the Claim Signature 618, digital signature values of the Claim 617 are stored.

In step S413, the control unit 205 stores user-defined Assertions such as the Assertions 614 to 616 in the Assertion Store 613. Furthermore, the control unit 205 generates the Claim 617 using the storage locations of the Assertions and the hash values of the Assertion Store 613 generated in step S411. Furthermore, the control unit 205 performs a digital signature on the Claim 617 via the digital-signature generation unit 218, thereby generating the Claim Signature 618. By the digital signature, the authenticity of the Assertions can be assured. Furthermore, the control unit 205 generates the Manifest 612 in which the Assertions 614 to 616, the Claim 617, and the Claim Signature 618 are stored. Furthermore, the control unit 205 generates the Manifest Store 611 in which the Manifest 612 is stored, and the uuid (“manifest”) box 610 in which the Manifest Store 611 is stored. In the manner described above, in step S413, the control unit 205 generates a C2PA moving-image file as illustrated in FIG. 6.

Note that the configuration illustrated in FIG. 6 is merely an example of a C2PA moving-image file, and a C2PA moving-image file may include other data stipulated by the C2PA standard. Furthermore, although the C2PA standard is exemplified as a moving-image file format in the present embodiment, any other format may be used as long as the above-described information on an authenticity assurance range (i.e., information indicating a verification range for which authenticity is to be verified) can be stored.

Referring back to FIG. 4, the processing of step S414 and subsequent steps will be described. In step S414, the control unit 205 stores the C2PA moving-image file in the recording medium 230 through the recording unit 210. Thereafter, in step S415, the control unit 205 may use the communication unit 217 to transmit the C2PA moving-image file to the verification device 300 and other external devices through the network 220.

In the flowchart of FIG. 4, the user performs, during imaging and recording of a moving image, marking on a scene for which authenticity is assured (i.e., a scene to be verified). However, when it is known in advance that the authenticity of the entire moving image is assured, the user may designate the entire moving image instead of designating a range. In this case, the Assertion 616 is written as (0, N), and all chunks become verification targets.

In the flowchart of FIG. 4, hash values are generated for all chunks in step S409 during recording of a moving image, and the hash values of all the chunks are retained in the Assertion 614. As another method, the control unit 205 may calculate hash values only for chunks included in an authenticity assurance range and retain them in the Assertion 614. By omitting the calculation of hash value for chunks outside the authenticity assurance range, the processing load for moving-image file creation can be reduced. In that case, in the Assertion 614, only the hash values of the chunks included in the authenticity assurance range (verification range) are stored, and hash values of the other chunks are not stored.

### Verification of Moving-Image File That Supports Authenticity Assurance

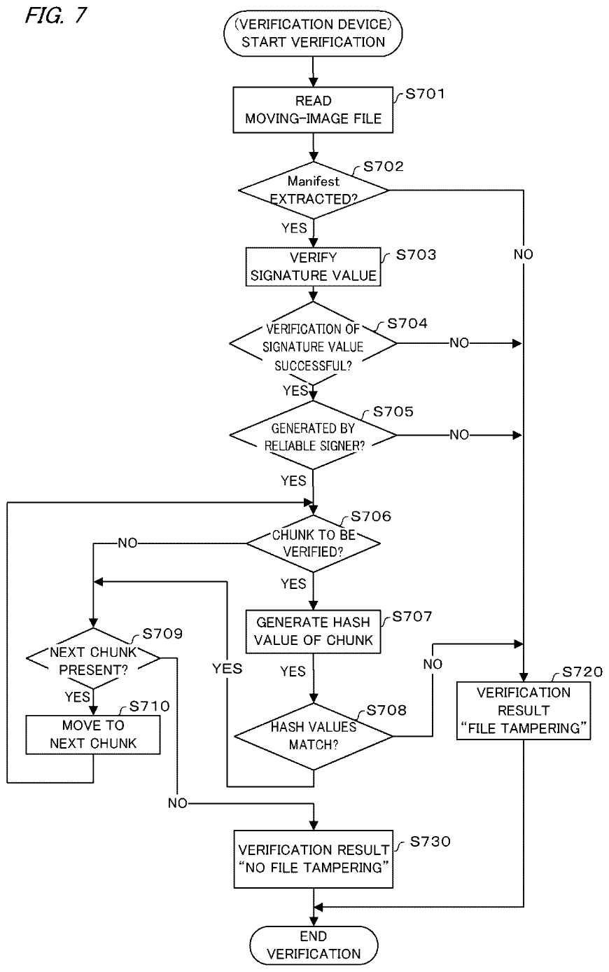

Next, the verification processing of a C2PA moving-image file (see FIG. 6) generated in step S413 will be described with reference to the flowchart of FIG. 7. This processing is implemented when the control unit 301 of the verification device 300 executes a program stored in the ROM 302, the storage unit 304, or the like.

First, in step S701, the control unit 301 reads, from the storage unit 304 into the RAM 303, a C2PA moving-image file to be verified illustrated in FIG. 6. The control unit 301 may alternatively receive the C2PA moving-image file to be verified illustrated in FIG. 6 from an external device, such as the imaging device 200 or the content providing device 400, through the network 310 and temporarily store the received file in the RAM 303.

Next, in step S702, the control unit 301 extracts, from the C2PA moving-image file, the Manifest 612 having a stipulated structure. When the Manifest 612 cannot be extracted (No in step S702), the processing proceeds to step S720. In step S720, the control unit 301 determines “file tampering” as a verification result of the C2PA moving-image file and ends this verification processing. On the other hand, when the Manifest 612 having the stipulated structure can be extracted (Yes in step S702), the processing proceeds to step S703.

In step S703, the control unit 301 verifies the signature value of the Claim Signature 618 of the Manifest 612 of the C2PA moving-image file to be verified using a public key. If the Claim Signature 618 was generated using a secret key paired with the public key, the signature value can be correctly decoded. When the signature value is successfully decoded, the control unit 301 further executes a hash function on binary data of the Assertion Store 613 to generate a hash value and determines whether the generated hash value matches the hash value decoded using the public key.

In step S704, the control unit 301 determines whether the verification of the signature value in step S703 has been successful. That is, when the signature value can be decoded using the public key and the hash values match, the control unit 301 determines that the verification of the signature value has been successful. Otherwise, the control unit 301 determines that the verification of the signature value has failed. When the verification of the signature value has failed (No in step S704), the processing proceeds to step S720. On the other hand, when the verification of the signature value has been successful (Yes in step S704), the processing proceeds to step S705.

In step S705, the control unit 301 determines whether the Claim Signature 618 of the C2PA moving-image file to be verified has been generated by a reliable signer. When the Claim Signature 618 has not been generated by a reliable signer (No in step S705), the processing proceeds to step S720. When the Claim Signature 618 has been generated by a reliable signer (Yes in step S705), the processing proceeds to step S706. Note that information on reliable signers is stored in advance in the storage unit 304. The control unit 301 makes the determination in step S705 depending on whether a signer matching the signer of the Claim Signature 618 is stored in the storage unit 304.

In step S706, the control unit 301 determines, in order from the first chunk (chunk 0 in FIG. 5), whether each chunk is a chunk to be verified (hereinafter, a chunk to be determined is referred to as an “attention chunk”). The control unit 301 reads a list of authenticity assurance ranges (verification ranges) written in the Assertion 616 and determines whether the attention chunk is a chunk to be verified on the basis of whether the attention chunk falls within an authenticity assurance range. When the attention chunk corresponds to a chunk to be verified, the processing proceeds to the verification processing of step S707. When the attention chunk does not correspond to a chunk to be verified, the verification processing is skipped, and the processing proceeds to step S709.

In step S707, the control unit 301 executes a hash function on binary data of the attention chunk to generate a hash value. Thereafter, in step S708, the control unit 301 compares the hash value generated in step S707 with a hash value of the attention chunk written in the Assertion 614 and determines whether these hash values match. When the control unit 301 determines that the hash values match, the processing proceeds to the processing of step S709. Otherwise, the processing proceeds to the processing of step S720.

In step S709, the control unit 301 determines whether a next chunk is present by referring to chunk management information in the moov box 620. When a next chunk is present, the processing proceeds to step S710. Otherwise, the processing proceeds to step S730. In step S710, the control unit 301 sets the next chunk as an attention chunk and returns to step S706. In step S730, the control unit 301 determines “no file tampering” as a verification result of the C2PA moving-image file and ends the verification processing.

According to the verification processing described above, when a C2PA moving-image file does not include a suitable Manifest, when the C2PA moving-image file is not given a reliable signature, or when a hash value of even one of the chunks falling within an authenticity assurance range does not match, it is determined that “file tampering” has occurred. On the other hand, when a C2PA moving-image file includes a suitable Manifest and is given a reliable signature, and when it is determined that hash values of all chunks falling within the authenticity assurance range match, it is determined that “no file tampering” has occurred.

For example, as illustrated in FIG. 5, when an authenticity assurance range is set to (3, 10) in a moving-image file, the control unit 301 determines in step S706 that chunks 0 to 2 are not verification targets and skips the processing of steps S707 and S708. Then, the control unit 301 determines that chunks 3 to 10 are verification targets and performs verification of hash values in steps S707 and S708, and determines that the remaining chunks 11 to N are not verification targets and skips the processing of steps S707 and S708. As described above, the control unit 301 performs verification only for chunks for which authenticity assurance has been performed, and does not perform unnecessary hash calculation processing and hash-value comparison processing for chunks for which authenticity assurance has not been performed. In other words, tampering with a moving-image file is determined by verifying a necessary and sufficient chunk range within the moving-image file. Accordingly, as compared with a conventional method (a method for verifying all chunks contained in a moving-image file), the time required to verify tampering with the moving-image file can be shortened. In addition, because important scenes marked by a moving-image provider (scenes for which authenticity is assured) are verified, the reliability of the verification result is also ensured.

### Second Embodiment

In the first embodiment, a method for recording an authenticity assurance range during imaging of a moving image has been described. In a second embodiment, however, a method for subsequently recording an authenticity assurance range for a recorded moving-image file will be described. Note that the configuration of the authenticity verification system 100 (FIG. 1), the configuration of the imaging device 200 (FIG. 2), and the configuration of the verification device 300 (FIG. 3) are the same as those described in the first embodiment, and therefore the descriptions thereof will be omitted. Furthermore, the flowchart of the verification processing of the verification device 300 is also the same as the flowchart (FIG. 7) described in the first embodiment, and therefore the description thereof will be omitted.

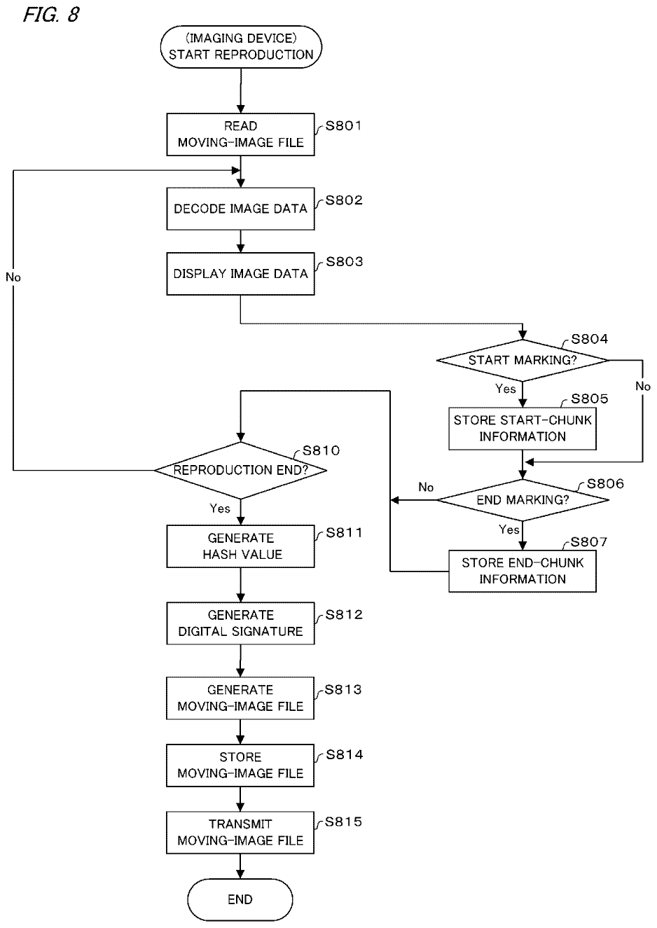

With reference to the flowchart of FIG. 8, processing performed by the imaging device 200 to generate, during reproduction, a moving-image file that supports authenticity assurance will be described. This processing is implemented when the control unit 205 of the imaging device 200 executes a program stored in the ROM 212 or the like. This processing starts when the imaging device 200 receives a reproduction start operation (e.g., pressing of a reproduction button, which is a part of the operation unit 214) from a user (operator).

First, in step S801, the control unit 205 reads a C2PA moving-image file from the recording medium 230 into the DRAM 201 via the recording unit 210. The control unit 205 may alternatively receive a C2PA moving-image file from an external device through the network 220 and temporarily store the received file in the DRAM 201.

In step S802, the control unit 205 extracts moving-image data in units of pictures from the mdat by referring to the moov box in the C2PA moving-image file, and transfers the pictures to the decoding unit 208. The decoding unit 208 writes the decoded image data to the DRAM 201.

In step S803, the control unit 205 reads the decoded image data from the DRAM 201 and transfers the read data to the image display unit 206. The image display unit 206 displays the decoded image data on the display panel.

Next, in step S804, the control unit 205 determines whether the imaging device 200 has received a chunk-marking start operation from the user. The chunk-marking start operation is an operation for designating a picture or a chunk at a start position. A picture can be designated, for example, by pressing a shot-mark button, which is a part of the operation unit 214. Note that, in addition to the shot-mark button used to designate a picture (frame image), a chunk-mark button used to designate a chunk may be provided, and a chunk at the start position may be designated using the chunk-mark button. When recognizing, during reproduction of a moving-image, the start of a scene for which authenticity is assured (e.g., a scene of high importance), the user may perform a chunk-marking start operation.

When the control unit 205 determines in step S804 that the chunk-marking start operation has been received, the processing proceeds to step S805. Otherwise, the processing proceeds to step S806.

In step S805, the control unit 205 stores start-chunk information indicating a chunk-marking start position in the DRAM 201 or the RAM 213.

Next, in step S806, the control unit 205 determines whether the imaging device 200 has received a chunk-marking end operation from the user. The chunk-marking end operation is an operation for designating a picture or a chunk at an end position. A picture can be designated, for example, by pressing a shot-mark button, which is a part of the operation unit 214. Note that when a chunk-mark button is provided, a chunk at the end position may be designated using the chunk-mark button. The user may perform the chunk-marking end operation when recognizing, during reproduction of a moving image, the end of a scene for which authenticity is assured (e.g., a scene of high importance).

When the control unit 205 determines in step S806 that the chunk-marking end operation has been received, the processing proceeds to step S807. Otherwise, the processing proceeds to step S810. In step S807, the control unit 205 stores end-chunk information indicating a chunk-marking end position in the DRAM 201 or the RAM 213.

In step S810, the control unit 205 determines whether the moving-image file has been reproduced to the end. When the reproduction has not been ended (No in step S810), the processing returns to step S802 to perform processing for a next picture. When the reproduction has been ended (Yes in step S810), the processing proceeds to step S811.

In the processing of steps S804 to S807, during reproduction of a recorded C2PA moving image, an authenticity assurance range can be designated and recorded by the user's own operation. The processing of steps S804 to S807 may be performed a plurality of times until a reproduction-end determination (S810) is made. That is, a plurality of authenticity assurance ranges (a plurality of pairs of start-chunk information items and end-chunk information items) may be recorded for a single C2PA moving-image file.

The processing of steps S811 to S815 is the same as that of steps S411 to S415 in the first embodiment, and therefore the description thereof will be omitted.

Here, with reference to a moving-image file format generated in accordance with the C2PA standard illustrated in FIG. 6, the structure of data newly added in the processing of steps S811 to S813 will be described.

The newly added data is data of the Manifest 612. Of the data of the Manifest 612, the Assertion 614 (a list of hashes for chunks) and the Assertion 615 (hash values of the moov box) are taken over from the Manifest of the original moving-image file.

The Assertion 616, the Claim 617, and the Claim Signature 618 of the Manifest 612 are newly generated. Generation of the Assertion 616, the Claim 617, and the Claim Signature 618 is the same as that described in the first embodiment, and therefore the description thereof will be omitted.

According to the method of the present embodiment, a scene of high importance for which authenticity is assured can be designated not only during imaging of a moving image but also during reproduction of a recorded moving image, and a moving-image file that supports authenticity assurance can be generated in the same manner as in the first embodiment. In addition, most of the data of the original C2PA moving-image file can be used as it is, and only a part of the data of the Manifest needs to be updated.

Furthermore, by using such a moving-image file that supports authenticity assurance, the verification side can perform verification only for chunks for which authenticity assurance has been performed, and can omit unnecessary hash calculation processing and hash-value comparison processing for chunks for which authenticity assurance has not been performed. Accordingly, as compared with a conventional method (a method for verifying all chunks contained in a moving-image file), the time required to verify tampering with the moving-image file can be shortened. In addition, because important scenes marked by a moving-image provider (scenes for which authenticity is assured) are verified, the reliability of the verification result is also ensured.

Note that in the present embodiment, an example in which an authenticity assurance range is additionally recorded for a C2PA moving-image file has been described. However, the original moving-image file may be a moving-image file in a format other than the C2PA standard. When the original moving-image file is in a format other than the C2PA standard, the Assertion 614 (a list of hashes for chunks) cannot be taken over. Therefore, hash values may be generated in units of chunks as described in step S409 of FIG. 4.

### Third Embodiment

In the second embodiment, a method for recording an authenticity assurance range during reproduction of a moving-image file has been described. In a third embodiment, however, a method for recording an authenticity assurance range during cutting and editing of a moving-image file will be described. Note that the configuration of the authenticity verification system 100 (FIG. 1), the configuration of the imaging device 200 (FIG. 2), and the configuration of the verification device 300 (FIG. 3) are the same as those described in the first embodiment, and therefore the descriptions thereof will be omitted. Furthermore, the flowchart of the verification processing of the verification device 300 is also the same as the flowchart (FIG. 7) described in the first embodiment, and therefore the description thereof will be omitted.

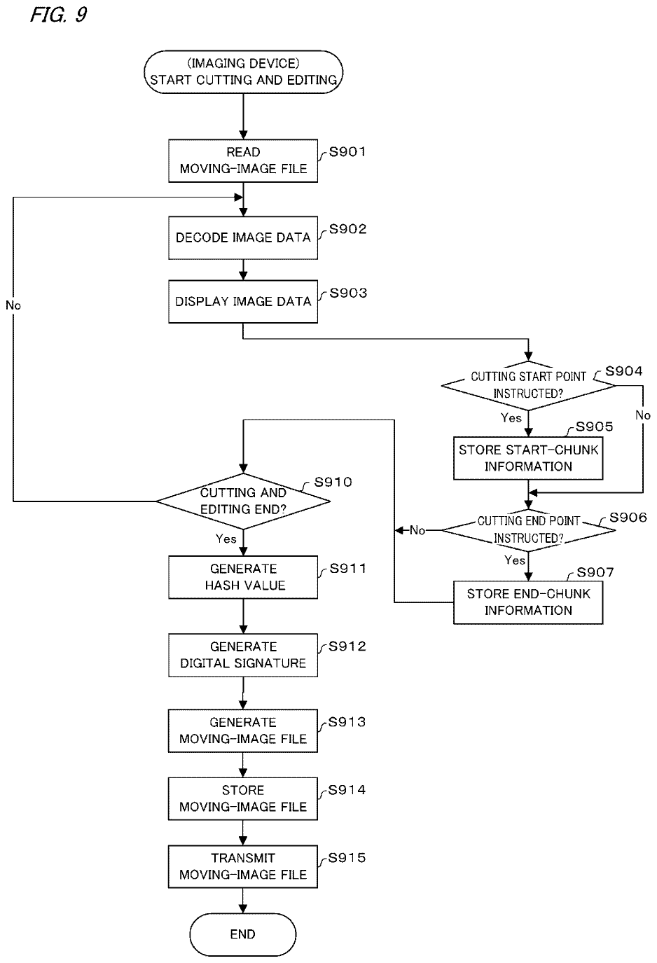

With reference to the flowchart of FIG. 9, processing performed during cutting and editing by the imaging device 200 to generate a moving-image file that supports authenticity assurance will be described. This processing is implemented when the control unit 205 of the imaging device 200 executes a program stored in the ROM 212 or the like. This processing starts when the imaging device 200 receives an editing start operation (e.g., pressing of an editing button, which is a part of the operation unit 214) from a user (editor).

The processing of steps S901 to S903 is the same as that of steps S801 to S803 in the second embodiment, and therefore the description thereof will be omitted.

Next, in step S904, the control unit 205 determines whether the imaging device 200 has received a cutting start-point instruction operation from the user. The cutting start-point instruction operation can be performed, for example, by pressing a shot-mark button, which is a part of the operation unit 214. Note that, in addition to the shot-mark button used to designate a picture (frame image), a chunk-mark button used to designate a chunk may be provided, and a chunk at a cutting start position may be designated using the chunk-mark button. Alternatively, a dedicated interface for cutting and editing may be used to designate a picture or a chunk at the cutting start position.

When the control unit 205 determines in step S904 that the cutting start-point instruction operation has been received, the processing proceeds to step S905. Otherwise, the processing proceeds to step S906.

In step S905, the control unit 205 sets a chunk including the cutting start point as a chunk-marking start position, and stores the chunk number in the DRAM 201 or the RAM 213 as start-chunk information.

Next, in step S906, the control unit 205 determines whether the imaging device 200 has received a cutting end-point instruction operation from the user. The cutting end-point instruction operation can be performed, for example, by pressing a shot-mark button, which is a part of the operation unit 214. Note that when a chunk-mark button is provided, a chunk at the cutting end position may be designated using the chunk-mark button. Alternatively, a dedicated interface for cutting and editing may be used to designate a picture or a chunk at the cutting end position.

When the control unit 205 determines in step S906 that the cutting end-point instruction operation has been received, the processing proceeds to step S907. Otherwise, the processing proceeds to step S910. In step S907, the control unit 205 sets a chunk including the cutting end point as a chunk-marking end position, and stores the chunk number in the DRAM 201 or the RAM 213 as end-chunk information.

In step S910, the control unit 205 determines whether the imaging device 200 has received a cutting-and-editing end instruction from the user. When the cutting-and-editing end instruction has not been received (No in step S910), the processing returns to step S902. When the cutting-and-editing end instruction has been received (Yes in step S910), the processing proceeds to step S911.

In the processing of steps S904 to S907, during cutting and editing of a recorded C2PA moving image, a chunk range including a scene cut out by the user is designated as an authenticity assurance range. Because it is highly likely that the scene cut out by the user is an important scene for which authenticity is assured, the convenience of editing can be improved by automatically setting the scene as an authenticity assurance range, as in the method of the present embodiment. Note that the processing of steps S904 to S907 may be performed a plurality of times until a cutting-and-editing end determination (S910) is made. That is, a plurality of authenticity assurance ranges (a plurality of pairs of start-chunk information items and end-chunk information items) may be recorded for a single C2PA moving-image file.

The processing of steps S911 to S915 is the same as that of steps S411 to S415 in the first embodiment, and therefore the description thereof will be omitted.

Here, with reference to a moving-image file format generated in accordance with the C2PA standard illustrated in FIG. 6, the structure of data newly added in the processing of steps S911 to S913 will be described.

The newly added data is data of the Manifest 612.

The control unit 205 acquires, from the Assertion Store of the Manifest in the original moving-image file, a hash list in which hash values for all chunks before cutting and editing are described. Then, the control unit 205 extracts only hash values for chunks cut out by the cutting and editing from the hash list, and generates a new hash list. This new hash list is recorded in the Assertion 614 of the moving-image file after the cutting and editing. As described above, because the control unit 205 can directly reuse a part of the data of the hash list in the original moving-image file, it is not necessary to newly calculate a hash value for each chunk.

The control unit 205 newly generates the moov 620 to refer to the chunks cut out by the cutting and editing. Then, the control unit 205 calculates hash values for the newly generated moov 620 via the hash-value generation unit 216, and generates the Assertion 615 that corresponds to the hash values of the moov 620.

Furthermore, the control unit 205 generates the Assertion 616, which corresponds to a list of authenticity assurance ranges, on the basis of the start-chunk information and the end-chunk information recorded in the processing of steps S904 to S907.

The Claim 617 and the Claim Signature 618 of the Manifest 612 are also newly generated. Generation of the Claim 617 and the Claim Signature 618 is the same as that described in the first embodiment, and therefore the description thereof will be omitted.

According to the method of the present embodiment, a scene of high importance for which authenticity is assured is automatically designated during editing of a recorded moving-image, and a moving-image file that supports authenticity assurance can be generated. In addition, because most of the data of the original C2PA moving-image file is used as it is, the time required to generate a moving-image file after editing can be shortened. Note that although an example of cutting and editing is provided in the present embodiment, the method of the present embodiment may be applied to other editing operations such as cropping.

### Other Embodiments

In the above-described embodiments, an example in which hash values are used as verification data for chunks has been described, but the present disclosure is not limited thereto. For example, watermarks, image features, timestamp information, metadata, or combinations of these data items may also be used as verification data. The type of verification data can be appropriately selected in consideration of processing load, reliability of verification, robustness against tampering, or the like.

In the above-described embodiments, an example in which a function as a moving-image file generation device according to the present disclosure is implemented in an imaging device has been described. An application target of the present disclosure is not limited to an imaging device, and the present disclosure may also be applied to an information processing device having the function of reproducing and editing recorded moving-image data. Examples of such information processing devices include, in addition to the content providing device 400 described in the above embodiments, smartphones, tablet terminals, video game consoles, personal computers, and wearable terminals.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present disclosure are also included in the present disclosure. The present disclosure also includes other configurations obtained by suitably combining various features of the embodiment.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, the time required to verify tampering with moving-image files can be shortened.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-051452, filed Mar. 26, 2025, which is hereby incorporated by reference herein in its entirety.

What is claimed is:

1. A moving-image file generation device comprising:
a processor; and
a memory storing a program which, when executed by the processor, causes the moving-image file generation device to
allow a user to designate, for moving-image data including a plurality of chunks, an authenticity assurance range representing a range of a moving-image for which authenticity is assured,
acquire, for each chunk, verification data used to verify tampering with data of the chunk, and
generate a moving-image file in which at least information indicating the authenticity assurance range designated for the moving-image data, the verification data for each chunk, and the moving-image data are stored.

2. The moving-image file generation device according to claim 1, wherein
the program, when executed by the processor, further causes the moving-image file generation device to generate a digital signature for the information indicating the authenticity assurance range and the verification data for each chunk, wherein
the digital signature is stored in the moving-image file.

3. The moving-image file generation device according to claim 1, wherein
a picture at a start position and a picture at an end position are designated from among a plurality of pictures constituting the moving-image data by the user, and a range as the authenticity assurance range is set from a chunk including the picture at the start position to a chunk including the picture at the end position.

4. The moving-image file generation device according to claim 1, wherein
a chunk at a start position and a chunk at an end position are designated from among a plurality of chunks constituting the moving-image data by the user, and a range as the authenticity assurance range is set from the chunk at the start position to the chunk at the end position.

5. The moving-image file generation device according to claim 1, wherein
designation of a plurality of authenticity assurance ranges for single moving-image data is allowed.

6. The moving-image file generation device according to claim 1, wherein
during imaging of a moving-image, the authenticity assurance range is designated for moving-image data sequentially acquired from an image sensor.

7. The moving-image file generation device according to claim 6, wherein,
each time data of one chunk is acquired, the verification data is calculated from the data of the one chunk.

8. The moving-image file generation device according to claim 7, wherein
the verification data only for chunks included in the authenticity assurance range is calculated, and
only the verification data for the chunks included in the authenticity assurance range is stored in the moving-image file.

9. The moving-image file generation device according to claim 1, wherein
during playing or editing of a recorded moving-image data, the authenticity assurance range is designated for the recorded moving-image data.

10. The moving-image file generation device according to claim 9, wherein
verification data for each chunk is added to the recorded moving-image data, and
verification data for chunks included in the authenticity assurance range is acquired from among the verification data for each chunk added to the recorded moving-image data.

11. The moving-image file generation device according to claim 1, wherein
the moving-image file is a C2PA moving-image file in a format complying with a C2PA standard.

12. The moving-image file generation device according to claim 11, wherein
the information indicating the authenticity assurance range is stored as a user-defined Assertion in a Manifest of the C2PA moving-image file.

13. An imaging device comprising:
an image sensor; and
the moving-image file generation device according to claim 1, wherein
the moving-image file generation device generates, on a basis of moving-image data captured by the image sensor, a moving-image file in which at least the information indicating the authenticity assurance range, the verification data for each chunk, and the moving-image data are stored.

14. A verification device comprising:
a processor; and
a memory storing a program which, when executed by the processor, causes the moving-image file generation device to
acquire a moving-image file in which at least moving-image data including a plurality of chunks, information indicating an authenticity assurance range representing a range of a moving image for which authenticity is assured, and verification data for each chunk used to verify tampering with data of each chunk are stored and
perform, on the basis of the information indicating the authenticity assurance range stored in the moving-image file, verification of tampering using the verification data for chunks included in the authenticity assurance range among the plurality of chunks of the moving-image data.

15. A control method of a moving-image file generation device, the control method comprising:
allowing a user to designate, for moving-image data including a plurality of chunks, an authenticity assurance range representing a range of a moving-image for which authenticity is assured,
acquiring, for each chunk, verification data used to verify tampering with data of the chunk, and
generating a moving-image file in which at least information indicating the authenticity assurance range designated for the moving-image data, the verification data for each chunk, and the moving-image data are stored.

16. A non-transitory computer readable medium that stores a program, wherein the program causes a computer to execute a control method of a moving-image file generation device, the control method comprising:
allowing a user to designate, for moving-image data including a plurality of chunks, an authenticity assurance range representing a range of a moving-image for which authenticity is assured,
acquiring, for each chunk, verification data used to verify tampering with data of the chunk, and
generating a moving-image file in which at least information indicating the authenticity assurance range designated for the moving-image data, the verification data for each chunk, and the moving-image data are stored.
